(19) United States
(12) Patent Application Publication
(10) Pub. No.: US 2025/0140779 A1
(43) Pub. Date: May 1, 2025

(54) METHOD FOR PRODUCING AN ELECTRODE OF A SOLID-STATE BATTERY CELL

(71) Applicant: VOLKSWAGEN AKTIENGESELLSCHAFT, Wolfsburg (DE)

(72) Inventors: Sven SCHOPF, Braunschweig (DE); Kartik ` JAMADAR, Wolfsburg (DE)

(21) Appl. No.: 18/691,247

(22) PCT Filed: Sep. 14, 2022
(86) PCT No.: PCT/EP2022/075533

§ 371 Date: Mar. 12, 2024

(30) Foreign Application Priority Data
Sep. 17, 2021 (DE) 10 2021 124 120.0

(51) Int. Cl. H01M 4/04; H01M 10/0525; H01M 10/0565

(52) U.S. Cl. CPC H01M 4/0416; H01M 4/0435; H01M 10/0525; H01M 10/0565; H01M 2300/0082

(57) ABSTRACT

A method for producing a first electrode of a battery cell including producing a main body of the first electrode having an active material of the first electrode and a copolymer and wetting the main body with a liquid electrolyte and forming a gel polymer electrolyte as a result of reaction of the copolymer with the liquid electrolyte and forming the first electrode.

### PRIORITY CLAIM

This patent application is a U.S. National Phase of International Patent Application No. PCT/EP2022/075533, filed 14 Sep. 2022, which claims priority to German Patent Application No. 10 2021 124 120.0, filed 17 Sep. 2021, the disclosures of which are incorporated herein by reference in their entireties.

### SUMMARY

Illustrative embodiments relate to a method for manufacturing an electrode of a solid-state battery cell. In the following, the term solid-state battery cell is also referred to as battery cell.

### BRIEF DESCRIPTION OF THE DRAWINGS

Disclosed embodiments are explained in more detail below with reference to the accompanying figures. It should be noted that the disclosure is not intended to be limited by the embodiments given. In particular, unless explicitly shown otherwise, it is also possible to extract partial facets of the matters explained in the figures and to combine them with other components and findings from the present specification. In particular, it should be noted that the figures and especially the proportions shown are only schematic.

FIG. 1 shows a sequence of a first exemplary embodiment of a disclosed method;

FIG. 2 shows a sequence of a second exemplary embodiment of a disclosed method;

FIG. 3 shows a sequence of a third exemplary embodiment of a disclosed method;

FIG. 4 shows a side view of a first exemplary embodiment of a device for applying a coating;

FIG. 5 shows a second exemplary embodiment of a device for applying a coating in a side view;

FIG. 6 shows a side view of a battery cell in section;

FIG. 7 shows a battery cell during an operation at b of the disclosed method;

FIG. 8 shows the battery cell of FIG. 7 after operation b;

FIG. 9 shows a part of the disclosed method;

FIG. 10 shows the wetting rollers of FIG. 9 in a view along the conveying direction;

FIG. 11 shows a side view of the wetting rollers of FIG. 10; and

FIG. 12 shows a microstructure of the wetting rollers of FIGS. 10 and 11.

### DETAILED DESCRIPTION

Batteries, in particular lithium-ion batteries, are increasingly being used to power transportation vehicles. In particular, for example, a transportation vehicle has an electrical machine for driving the transportation vehicle, whereby the electrical machine can be driven by the electrical energy stored in the battery cell. Batteries are usually composed of battery cells, with each battery cell having a stack of anode, cathode and separator sheets. At least some of the anode and cathode sheets are designed as current arresters to conduct the current provided by the cell to a consumer located outside the cell. Battery cells with liquid or solid electrolytes (solid-state battery) are known.

The electrode described here is used in a solid-state battery cell (ass battery cell; all-solid-state battery cell and polymer gel battery cell), which therefore comprises exclusively solid components (including semi-solid electrolytes, e.g., polymers, i.e., also a solid or gel-like electrolyte and therefore not a liquid electrolyte). These solid or gel-like electrolytes are arranged both as ion-conducting separators between the electrodes and for ion conduction within the electrodes. These separators are usually made of ceramic materials or of polymer, glass or hybrid materials.

In particular, a solid-state battery cell comprises a gas-tight housing and at least one stack of electrode foils or layers, also known as electrodes, arranged one on top of the other. The housing can be designed as a dimensionally stable housing (prismatic cell) or at least partially made of an elastically deformable film material (pouch cell). A combination of both types of housing is also possible.

When manufacturing an electrode of a solid-state battery cell, a so-called carrier material, in particular a strip-shaped carrier material, e.g., a carrier film/foil, is coated on one side or both sides at least partially with an active material (in particular, additionally comprising the solid electrolyte, a gel-shaped electrolyte may be provided later). The current arresters (arrester tabs) formed on the electrode are formed by uncoated areas of the carrier material. The carrier material comprises, for example, copper, a copper alloy, aluminum or an aluminum alloy.

The coating of active material produced in this way is initially porous. The porosity is reduced by calendering, as the coating is compacted here. The compaction is necessary to increase the specific capacity (in relation to the volume) and electrical conductivity or to ensure charge transport through materials of the active material that are in contact with each other.

The active material of a solid-state battery cell is compressed to a porosity of less than 1% during calendering; in the case of gel electrolytes, in particular, a greater porosity is maintained. The porosity is reduced by between 20% and 50% as a result of calendering. The calendering process is similar to the rolling process. The active material is subjected to a calendering force in a deformation zone and compressed. A calender comprises several rollers that form at least one gap through which the electrode is conveyed along a conveying direction.

Polymer electrolytes intended for use in lithium cells can be divided into two main categories:
(1) those based on pure high polymers that serve both as a solvent to dissolve lithium salts and as a mechanical matrix to aid processability, and
(2) those based on polymers gelled by conventional electrolyte solutions, where the small organic molecules serve as the main solvent, while the small proportion of high polymers fully swollen by these solvents serves only to ensure dimensional stability.

The former polymer electrolytes are usually referred to as solid polymer electrolytes (SPE), the latter as gel polymer electrolytes (GPE). Due to their poor ionic conductivity at room temperature, SPEs have little chance of being used. GPEs, on the other hand, have proven to be much more practical, and second-generation lithium-ion cells (such as all-solid-state batteries) are already being produced with these new types of electrolytes.

GPEs are mainly used within the cathode in solid-state batteries and are therefore also referred to as catholytes. For this purpose, a hot polymer solution (approx. 90° C. [degrees Celsius]) is made from a polymer (e.g., based on poly(vinylidene fluoride-co-hexafluoropropylene), i.e., PVdF-HFP) is used, which is mixed with a convection electrolyte such as propylene carbonate (PC), dimethylene carbonate (DMC) and lithium salts such as lithium hexafluorophosphate (LiPF6) or new lithium salts such as lithium bis(fluorosulfonyl)imide (LiFSi).

The conventional method of introducing GPEs into the cathode can include the following drawbacks:
Usually, GPE is applied in a hot state after calendering with an excess amount of conventional electrolytes to reduce its viscosity and increase the wetting of the porous electrode structure; after cooling, the GPE-coated electrode with its gel-like behavior makes it difficult to stack the cathode with the anode and separator; due to the sticky nature of the gel-like coating, it is difficult to handle the cathode for further work.
In the conventional method of producing a GPE, the liquid electrolyte must be heated together with the polymer to form the gel, whereby the thermal instability of the lithium salt (LiPF6 or LiBF4) and the volatility of the solvents (DMC, EMC, etc.) can cause the resulting gel to be too hot. In addition, conventional electrolytes such as LiPF6/EC (ethylene carbonate)/DMC cannot be used because, for example, the lithium salt LiPF6 is not stable at temperatures above 55° C. DMC also begins to boil at 90° C.; as a result, expensive lithium salts such as lithium bis(fluorosulfonyl)imide (LiFSi), which are thermally more stable at this temperature, must be used.
LiPF6 forms hydrofluoric acid (HF) very quickly in the presence of even low humidity, which is why the entire process must be carried out in a dry room after the GPEs have been placed on the cathode; this increases the cost of production.
To form GPE, it is important that the liquid electrolyte swells the polymer; the swelling of PVdF-HFP by liquid electrolytes is never complete due to the semi-crystalline nature of the copolymer, which tends to microphase-development and separation after activation by the liquid electrolyte; this multiphase nature of GPE (liquid, gel and crystalline solid) makes it difficult to handle it in the next processes such as cutting and stacking.
During calendering, the pores in the active material of the electrode are reduced; GPE is currently applied to the cathode after calendering; due to the small pore size, it is difficult for the liquid electrolyte and GPE to penetrate into the pores of the active material; a high temperature is required to reduce the viscosity so that the electrolyte and GPE can penetrate into the pores. The high temperature leads to further deterioration of the electrolyte.

To summarize, the current method of introducing GPE into and onto the cathode surface is not an efficient method.

The following measures could be considered to avoid the aforementioned problems that occur with the conventional method of applying GPE:
A use of more expensive lithium salts such as lithium bis(fluorosulfonyl)imide (LiFSi), which are more thermally stable at temperatures around 90° C.
Increasing the amount of low-viscosity solvent (e.g., dimethylene carbonate (DMC) in liquid electrolyte) as excess electrolyte to improve the wetting of the electrode or active material; this requires an additional drying action (inefficient and time-consuming).
Increasing the process temperature to lower the viscosity; in this case, other solvents or additives must be used to avoid boiling of the DMC at around 90° C.; a low processing temperature can contribute to stable DMC, but again has negative effects as the viscosity of the liquid electrolyte increases and it cannot penetrate the pores of the active material as easily.
Since LiPF6 is sensitive to moisture, the entire process of preparing GPE and applying it to the cathode must be carried out in a dry room; all subsequent processes should also be carried out in a dry room.
The handling of the GPE-coated cathode during subsequent processes such as cutting and stacking is still an unsolved problem.

The main drawbacks of the above measures are as follows:
higher cost of GPE due to more expensive lithium salts;
drying room leads to high production costs;
high temperatures (approx. 90° C.) required for GPE decompose other components of the liquid electrolyte, namely lithium salt LiPF6 and dimethylene carbonate (DMC);
a gel-like surface of the cathode leads to handling problems in the subsequent process, such as cutting and stacking the electrodes.

DE 100 20 031 A1 describes a method for manufacturing a lithium polymer battery. The polymer gel electrolyte is laminated onto a continuous collector foil together with the active material for the anode and the active material for the cathode.

WO 01/82403 A1 discloses a method for producing a lithium polymer battery.

A method for producing a laminated component of a battery cell is known from WO 02/19450 A1. The laminated component comprises a layer of a gel polymer electrolyte and a layer of an active material.

The disclosed embodiments at least partially solve the problems cited with reference to the prior art. In particular, a method for producing an electrode of a solid-state battery cell is to be proposed, with which the cutting and/or stacking of the individual electrodes is simplified.

Disclosed embodiments provide a method to solving these problems. The features listed individually in the claims can be combined with each other in a technologically meaningful way and can be supplemented by explanatory facts from the description and/or details from the figures, whereby further embodiments of the disclosure are shown.

A method for manufacturing a first electrode of a solid-state battery cell (hereinafter referred to as battery cell) is proposed. The method comprises at least the following:
a) producing a base body of the first electrode, at least comprising an active material of the electrode and a copolymer;
b) wetting the base body with a liquid electrolyte and forming a gel polymer electrolyte by reacting the copolymer with the liquid electrolyte and forming the first electrode.

The known process for producing a homogeneous GPE coating on an electrode is not efficient and is replaced by a two-stage process in which first a base body of an electrode is provided which has only a copolymer as the starting material for the gel polymer electrolyte. At least the cutting of the electrode material to the geometry of the electrode present in a solid-state battery cell takes place in this state. Only then, after the electrodes have been stacked on top of each other to form a stack and the stack has been arranged in a housing of the solid-state battery cell, is an electrolyte added and the gel polymer electrolyte formed.

In operation at a), the active material is provided and, if necessary, arranged on a carrier material. When manufacturing an electrode of a solid-state battery cell, a carrier material, in particular, a strip-shaped carrier material, e.g., a carrier film, can be at least partially coated with an active material on one or both sides. The current arresters (arrester tabs) formed on the electrode are formed by uncoated areas of the carrier material. The carrier material comprises, for example, copper or a copper alloy for the anode and aluminum or an aluminum alloy for the cathode. The base body can therefore comprise the active material, the carrier material and the copolymer.

In particular, the copolymer is mixed with the active material in operation at a) to form a material mixture and the material mixture is arranged on a carrier material. In particular, the copolymer is arranged substantially uniformly distributed in the material mixture. If the gel polymer electrolyte is then formed in operation at b), the gel polymer electrolyte is also evenly distributed in the material mixture of the first electrode that is then formed.

However, this mixing of the copolymer may have drawbacks. For example, a reaction of NMP (N-methyl-2-pyrrolidone; a solvent for the production of the coating mass of the first electrode containing the active material) with the copolymer can lead to a thickening and thus to an increase in the viscosity of the coating mass. This can lead to problems when coating a carrier material (e.g., an aluminum and/or copper substrate) of the first electrode with the coating mass or irreversibly damage the copolymer of the subsequent gel polymer electrolyte.

It is desirable that a surface of the first electrode is completely covered with the gel polymer electrolyte. In this way, the gel polymer electrolytes have better contact with the solid electrolyte separator used in the battery cell. This facilitates ion transfer. In particular, this gel polymer electrolyte layer on the surface of the first electrode cannot be produced if the copolymer is mixed with the active material to form the material mixture.

The copolymer may therefore be applied as a coating to the active material in an operation at a1) carried out during operation at a). In particular, the copolymer is additionally arranged in the active material as a material mixture. Alternatively, the copolymer is arranged exclusively in the coating.

In solid-state batteries, normally only the cathode is coated with gel polymer electrolytes, while the anode is made of lithium metal. In other polymer gel battery cells or solid-state battery cells, both the anode and cathode can be coated with gel polymer electrolytes. Since both the cathode and anode composite materials are coated on their substrates with the same copolymer (e.g., PVdF-HFP) as a binder, the three components (anode, cathode, gel polymer electrolyte separator) of the battery cell effectively merge into an integrated multilayer wafer without physical boundaries due to the gelation after electrolyte activation, so that the boundary layers between anode and electrolyte and/or cathode and electrolyte extend far into the porous structures of these electrodes, which is very similar to the boundary layers to which a liquid electrolyte would have access. This increases the ionic conductivity of the gel polymer electrolytes and also the dimensional stability.

In particular, if a lithium metal is used as the anode, only the base body, which is designed as the cathode, must be charged with the liquid electrolyte to form the gel polymer electrolyte from the reaction of the copolymer with the liquid electrolyte. If the battery cell is manufactured without lithium metal, the same method can also be used for the anode and the anode can also be charged with the liquid electrolyte to form the gel polymer electrolyte.

The first electrode may be a cathode. The first electrode can also be configured as an anode.

In at least one disclosed embodiment of the method, a copolymer, e.g., PVdF-HFP, is applied to the active material as a microporous coating after a (first) calendering of an active material. The calendering can be carried out as a two-stage calendering process with integrated coating.

The copolymer (e.g., PVdF-HFP) can be applied as a coating in different ways. For example, the copolymer can be sprayed onto the surface of the base body (i.e., only the active material) using a nozzle, e.g., a Venturi-based nozzle (also referred to as a high-speed blasting process). In particular, the nozzle is pressurized with dry air at high pressure (approx. 6 bar). The copolymer particles enter the nozzle. The high air pressure is converted into a high air velocity. The high velocity air (maximum 0.3 to 4 Mach) takes the copolymer particles with it and bombards them onto the surface of the base body, especially if it is already calendered. In this way, a thin coating with a thickness of a few micrometers can be produced.

Alternatively or additionally, copolymer particles are picked up by deposition rollers and pressed onto the surface of the base body, especially if it has already been calendered.

After the base body has been coated with the coating, e.g., a thin microporous layer of PVdF-HFP, the base body, at least consisting of the active material and the copolymer, is calendered, in particular, calendered (a second time), in an operation at a2) before operation at b).

In the second calendering process, only the copolymer coating is pressed onto the base body, in particular, onto the active material, so that it adheres well to the surface of the base body. The density of the (PVdF-HFP) coating is not significantly increased. After the second calendering, the copolymer (PVdF-HFP) adheres strongly to the surface of the base body and also has sufficient porosity. This porosity is important for the formation of the gel polymer electrolyte in operation at b).

In particular, the active material is calendered during operation at a) and before operation at a1) in an operation at a0). Calendering has already been explained at the beginning. The calendering process is similar to the rolling process. The active material (i.e., possibly still without copolymer) is subjected to a calendering force in a deformation zone and compressed.

A calender comprises several rollers that form at least one gap through which the base body of the first electrode (here, in particular, only the active material and possibly also the carrier material coated with the active material) is conveyed along a conveying direction.

In particular, the active material is wetted with a pore-forming material during operation at a) and thereby before or during operation at a0).

In particular, the coating is wetted with a pore-forming material during operation at a).

For example, the pore-forming material can vaporize at a certain temperature and thus be expelled from the base body, i.e., from the coating and/or the active material or the material mixture, by heating the base body. During vaporization, pores are created in the base body, in particular. The space occupied by this pore-forming material in the base body is now empty after this pore-forming material, which boils at low temperatures, has evaporated. In this way, the porosity required for the formation of the gel polymer electrolyte can be maintained.

Another way to create porosity is to use such pore-forming materials that are soluble in DMC, for example. These dissolve in DMC on the surface of the base body or coating (e.g., in the micropores created by the wetting rollers). This DMC on the surface can be removed by cleaning the base body with the aid of wiping/scraping rollers, so that the pore-forming agent is removed and pores are thus formed in the copolymer coating on the base body.

In particular, this means that at least two processes exist to create pores in the coating. On the one hand by a thermal process and on the other hand by a chemical solubilization process. However, this generation of pores is only necessary if the porosity of the copolymer coating is low.

In particular, the base body is passed through a tank filled with the pore-forming material to wet it with the pore-forming material. The pore-forming material includes DMC (dimethylene carbonate), for example. In particular, the tank filled with DMC is pressurized by nitrogen gas so that no outside air can penetrate. When the first electrode passes through the tank, the pore-forming material penetrates into the pores of the active material.

A pressure roller or wetting roller can be provided, which exerts pressure on the base body so that the mechanical pressure causes more DMC to enter the active material of the base body. In particular, the wetting roller causes a microstructure on the surface of the base body. In this way, more DMC will adhere to the surface of the base body in the pores and/or micropores.

Wiper/scraper rollers can also be provided to remove excess pore-forming material from the surface of the base body. In particular, the excess pore-forming material can be returned to the tank.

The pores of the base body are then filled with the pore-forming material. The base body can then be calendered, in particular, in an operation at a2).

In operation at a2), the base body can be compacted to a final density, e.g., to 3.6 g/cm³ [grams/cubic centimeter] for typical NMC material (i.e., the material of a lithium-nickel-cobalt-manganese battery cell).

DMC is selected as the pore-forming material, as it has a boiling point of 90° C. This is removed from the base body at a later stage of the process, in particular by vaporization.

When DMC leaves the surface of the base body, it forms new pores or increases the pore diameter on the surface. This leads to increased porosity. As a result, the copolymer applied as a coating can penetrate the pores of the first electrode or the base body more easily.

The microstructure created by the wetting roller contributes to the subsequent copolymer coating adhering to the surface of the base body.

During calendering according to operation at a2), a polyurethane protective film, for example, can be used on one or both sides. In this way, the DMC will not leak out of the sides of the base body. The polyurethane film can be placed on the base body before entering the calender roll and rewound after exiting the calender. In this way, the same film can be used again.

In particular, the material mixture is wetted with a pore-forming material during operation at a).

In particular, the pore-forming material is at least partially removed from the base body before operation at b).

In particular, the base body, at least comprising the active material and the copolymer, is calendered in an operation at a2) before operation at b).

In particular, the base body is free of gel polymer electrolyte immediately before operation at b).

In particular, the first electrode is cut to a geometry predetermined for operation in a battery cell before operation at b).

The cutting of the base body, which is designed as a continuous material, comprises in particular slitting (cutting line runs along the extension, x-direction, of the continuous material to divide the wide starting material of the base body into several less wide strips of continuous material), notching (the arresters are formed out of the continuous material with the cutting line; the cutting lines run longitudinally and transversely to the extension of the continuous material, e.g., along the y-direction and the x-direction), and/or separating (the cutting line runs transversely to the extension of the continuous material along the y-direction; by separating, the base bodies are cut off from the continuous material and the individual layers or electrodes of the stack are formed).

Since only the copolymer and no gel polymer electrolyte is present before operation at b), i.e., gel formation has not yet taken place, the base body is particularly easy to handle.

In particular, the base body or the first electrode is dried between operations at a) and b).

In particular, the base body is heated to a temperature of approx. 90° C. and dried in the process. If the pore-forming material has been placed in the active material and/or in the material mixture, this pore-forming material boils and vaporizes. When the vapor bubbles of the pore-forming material emerge from the surface of the base body, they form new pores or increase the diameter of the existing pores. This increases the porosity in the active material and in the coating, if present.

If the pore-forming material is located in the coating, the pore-forming material is released as a result of the heating and removed from the coating. This increases the porosity of the coating.

The pore-forming material that escapes from the base body or the coating during drying can be collected and, if necessary, recycled for reuse.

It is possible that pore-forming material remains in the pores of the base body or coating after heating. This is not harmful, as the pore-forming material, e.g., DMC, may be part of the liquid electrolyte that is used in operation at b) to wet the first electrode.

For this reason, DMC or a similar suitable pore-forming material is used, which can therefore be used to form pores and is also an electrolyte component. In addition, DMC is also harmless to health and VOC-free (free from volatile organic compounds).

After trimming to the predetermined geometry, the first electrode can be arranged in a stack, in particular with other electrodes. Because there is no gel-like material on the first electrode at this stage, it is easy to handle when stacking.

In particular, the first electrode is stacked with at least one second electrode after operation at a) and before operation at b) and the electrodes form a stack.

In particular, the stack is arranged in a housing of the battery cell before operation at b).

In particular, stacking can be carried out in a known way. It can be carried out as a Z-fold, i.e., with a continuous layer that has alternating folded edges, or using the pick-and-drop method, i.e., as separate layers. In the pick-and-drop method, cathode-separator-anode stacks are produced.

After stacking, the current arresters are connected or welded together on the anode side, in particular using nickel-based connecting elements. Similarly, on the cathode side, aluminum current arresters are connected or welded together, in particular using an aluminum connecting element.

The stack, in particular with the respective connected current arresters, is then arranged in a housing of the battery cell. The housing can be designed as a pouch cell housing or as a housing that can only be plastically deformed (prismatic battery cell). If it is a pouch cell housing, the edges of the pouch cell housing are sealed in a known way to ensure a gas-tight seal. In particular, the housing has a gas pocket in a known way, in which the gas released during the formation of the battery cell can be collected.

After the housing has been at least partially sealed, the liquid electrolyte is then introduced into the housing.

In operation at b), in particular a liquid electrolyte, e.g., PC (polypropylene carbonate) and/or DMC (dimethylene carbonate) with dissolved lithium salt (e.g., lithium hexafluorophosphate-LiPF6 or lithium bis(fluorosulfonyl)imide-LiFSi) is fed at least to the first electrode and to the stack. The amount of liquid electrolyte is very small, as the main function of the electrolyte is to produce a gel polymer electrolyte with the copolymer.

Once the electrolyte has been added, the housing, e.g., the still open edge of the pouch cell housing, is closed or sealed.

In particular, the electrolyte is filled under a nitrogen atmosphere and/or vacuum so that the air can escape from the battery cell or the housing during electrolyte filling.

In particular, the formation of the gel polymer electrolyte is activated at least by supplying thermal or mechanical energy.

As a result of the wetting of at least the first electrode, the liquid electrolyte penetrates into the pores of the first electrode or the base body or the coating. The liquid electrolyte reacts with the copolymer and is activated. Activation requires energy, which can be provided by heat or mechanical force, for example. After activation, the liquid electrolyte swells the originally microporous film (the base body and/or the coating) and finally forms a gel polymer electrolyte.

Wetting and activation takes place by applying mechanical force to the first electrode or the stack. For example, the stack arranged in a pouch cell housing can be pressed and compressed between two rotating rollers. The mechanical force causes the liquid electrolyte to penetrate into the pores. However, this method may be less suitable due to possible damage to the housing and separator.

Wetting and activation can also be carried out (possibly additionally) using thermal energy. For this purpose, at least the first electrode or the stack and/or the housing with stack is subjected to thermal energy, e.g., by placing it in an oven. At least the first electrode is heated to approx. 50° C. for this purpose. If LiFSi is used as the lithium salt, the heating can also be up to 80° C. As a result of the heating, the thermal energy is used by the electrolyte to penetrate the pores and activate the copolymer for the production of the gel polymer electrolyte.

After the wetting process, the solid-state or polymer battery is ready to be formated. In particular, at least 90%, optionally at least 95%, particularly optionally 100%, of the copolymer has been transformed into the gel polymer electrolyte.

In particular, the stack can be activated by a liquid electrolyte (especially with lithium salt) during the electrolyte filling process in a similar way as a conventional polyolefin separator is activated by a liquid electrolyte. Due to the porosity of the coating or the base body, the liquid electrolyte can penetrate the coating or the base body. After activation, the liquid electrolyte swells the originally microporous coating or base body and finally forms a gel polymer electrolyte with the copolymer.

To accelerate the wetting process of the copolymer, a portion of the liquid electrolyte can be added, particularly before calendering.

In particular, in the proposed method, the only action that needs to be carried out in a humidity-controlled environment is the addition of the liquid electrolyte to the stack. Thus, the benefits of the proposed method are obvious, especially in terms of manufacturing costs and equipment requirements.

In battery cells, only the cathode is normally coated with gel polymer electrolytes, while the anode is made of lithium metal. In other polymer gel batteries, both the anode and cathode can be coated with gel polymer electrolytes. Since both the cathode and anode composite materials are coated with the same PVdF-HFP copolymer as a binder, for example, especially on their substrates or carrier materials, the three components of the battery cell effectively merge into an integrated multilayer wafer without physical boundaries due to gelation after electrolyte activation, so that the interfaces between anode and electrolyte or cathode and electrolyte extend far into the porous structures of these electrodes. This is very similar to the boundary layers to which a liquid electrolyte would have access. This increases the ionic conductivity of the gel polymer electrolytes and also the dimensional stability.

In particular, the method can be used for both solid-state batteries and polymer gel battery cells. In a battery cell, lithium metal is used as the anode, so that the proposed method is used only to produce the cathode. In the case of polymer gel battery cells, the method can be used to produce the cathode and the anode. If the battery cell is therefore produced without lithium metal, the method can be used for both electrodes.

In battery cells with lithium as the metallic anode, the application of the liquid electrolyte and the wetting of the first electrode takes place before the electrodes are stacked. In particular, problems can occur if the liquid electrolyte comes into contact with the lithium metal, the adhesive foil, the nickel plate and the copper substrate of the anode. If the liquid electrolyte has no negative effects on the lithium metal on the anode, then the wetting of the electrode can also be carried out after stacking.

In particular, the proposed method differs from known methods for manufacturing solid-state battery cells in at least the following respects:
In the present method, the gel polymer electrolyte is not formed immediately after calendering, but only after electrolyte filling and activation.
In known methods, no filling of the housing with a liquid electrolyte is provided; in the present method, it is proposed to supply a liquid electrolyte which activates the copolymer to form gel polymer electrolytes.
Only the coating of the active material with the copolymer is a new method, at least for the manufacture of battery cells; the other method operations mentioned are already known and are now proposed for the first time in a different combination; the coating with the copolymer can be carried out by high-speed blasting or by pressing with deposition rollers.
In particular, the first electrode designed as a cathode has no gel-like electrolyte coating during the cutting of the electrode, the connection of the electrodes with current collector elements and the stacking process.
There is no need to produce the gel polymer electrolyte externally and then apply it to the cathode; the gel polymer electrolyte is produced inside the battery cell.
The porosity of the base body or the coating can be increased by pore-forming materials; in known methods, the porosity is maintained by a lower density during calendering; in the present case, in particular, the calendering of the active material is not changed; in particular, the first electrode is fully compacted to the desired density.
In particular, the pore-forming materials are released during the drying process; they can be collected and recycled.
It is not necessary to apply gel polymer electrolytes at high temperature (approx. 90° C.), on the cathode; the gel polymer electrolyte is evenly distributed at a moderately low temperature after wetting of at least the first electrode; the wetting takes 3 to 4 hours, so that approx. 50° C. may be sufficient.
“Normal” and inexpensive lithium salts such as lithium hexafluorophosphate can be used instead of more expensive lithium salts such as LiFSi.
In particular, it is also possible to use other copolymers such as polyethylene oxide (PEO), polyacrylonitrile (PAN), polymethyl methacrylate (PMMA); in the present case, the use of copolymers consisting of polyvinylidene fluoride (PVdF) together with hexafluoropropylene (HFP) was proposed as an exemplary embodiment.

Compared to known methods, the following benefits can be realized:
Easy handling of the first electrode during the various operations of the method, since the formation of the gel polymer electrolyte takes place in a later phase.
No need for a dry atmosphere for electrode production; therefore great savings in energy costs.
Gel polymer electrolyte and liquid electrolyte can penetrate into the pores of the first electrode and/or the base body and/or coating without the need to provide excessive heat energy (as in known processes).
No need for expensive lithium salt such as LiFSi.
Most conventional battery manufacturing methods can be used, thus reducing the effort required to realize the proposed method.
In particular, the stack can be activated by a liquid electrolyte (especially with lithium salt) during the electrolyte filling process in a similar way as a conventional polyolefin separator is activated by a liquid electrolyte.
The method is more suitable for the mass production of solid-state battery cells than the currently known methods.
A lower temperature is required for gel polymer electrolyte production in the battery cell, so that electrolyte degradation does not occur or only occurs to a small extent.
There is no thermal decomposition of the lithium salts.
The gel polymer electrolyte can suppress dendrite formation in the lithium metal and thus reduce the risk of thermal runaway.
The first electrode can be compressed to a high density using conventional calendering, resulting in a high volumetric energy density.
Higher porosity of the first electrode can deliver high current (high C-rate) and thus high power.

In short, the production of the gel polymer electrolyte in an already assembled battery cell (i.e., when the first electrode is already arranged in a stack and the stack is already in the battery cell housing) can drastically facilitate the production of solid-state batteries or polymer gel batteries.

The method can be carried out by a system for data processing, e.g., a control unit, the system having methods or mechanisms which are suitably equipped, configured or programmed to carry out the operations of the method or which carry out the method. The system can at least be used to control the device components used for the method.

The methods or mechanisms comprise, for example, a processor and a memory in which instructions to be executed by the processor are stored, as well as data lines or transmission devices which enable the transmission of instructions, measured values, data or the like between the aforementioned components of the device components used for the method.

There is further proposed a computer program comprising instructions which, when the program is executed by a computer, cause the computer to carry out the described method or the operations of the described method.

There is further proposed a computer-readable storage medium comprising instructions which, when executed by a computer, cause the computer to perform the described method or the operations of the described method.

A battery cell is further proposed, at least comprising a housing and arranged therein a stack of electrodes, at least comprising at least one electrode, which is produced by the method described.

In particular, a battery cell comprises a housing enclosing a volume and, arranged in the volume, at least one first electrode of a first electrode type, a second electrode of a second electrode type and a separator material or a solid (also gel-like) electrolyte arranged therebetween.

The battery cell is a pouch cell (with a deformable housing consisting of a pouch foil) or a prismatic cell (with a dimensionally stable housing). A pouch foil is a known deformable housing part that is used as a housing for so-called pouch cells. It is a composite material, e.g., comprising a plastic and aluminum.

The battery cell is a lithium-ion battery cell.

The individual layers of the plurality of electrodes are arranged on top of each other and form a stack. The electrodes are each assigned to different electrode types, i.e., they are designed as an anode or a cathode. The anodes and cathodes are arranged alternately and separated from each other by the separator material or the electrolyte.

A transportation vehicle is further proposed, at least comprising a traction drive and a battery with at least one of the battery cells described, wherein the traction drive can be supplied with energy by the at least one battery cell.

The descriptions of the method are transferable to the battery cell, the transportation vehicle, the system for data processing and the computer-implemented method (i.e., the computer or the processor, the computer-readable storage medium) and vice versa.

The use of indefinite articles (“a”, “an”), in particular in the claims and the description reproducing them, is to be understood as such and not as a number word. Accordingly, terms or components introduced thereby are to be understood as being present at least once and, in particular, may also be present more than once.

As a precaution, it should be noted that the number words used here (“first”, “second”, . . . ) are primarily (only) used to distinguish between several similar objects, quantities or processes, i.e., they do not necessarily specify any dependency and/or sequence of these objects, quantities or processes in relation to one another. If a dependency and/or sequence is required, this is explicitly stated here or is obvious to the person skilled in the art when studying the specific embodiment described. Insofar as a component may occur more than once (“at least one”), the description of one of these components may apply equally to all or some of the plurality of these components, but this is not mandatory.

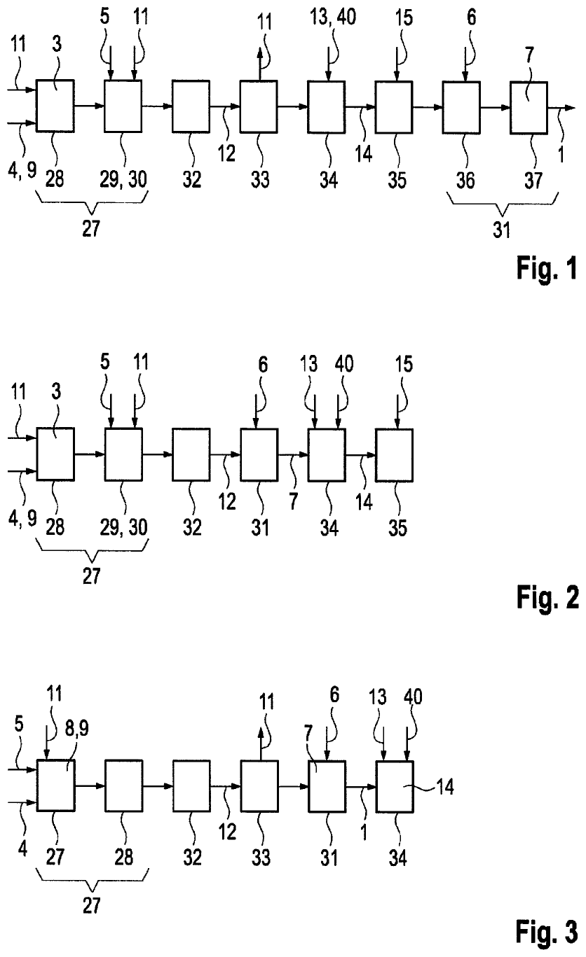

FIG. 1 shows a sequence of a first disclosed embodiment of a method. In operation at a) 27, the active material 4 is provided and, if necessary, arranged on a carrier material 9. The base body 3 has the active material 4 and the carrier material 9. The active material 4 is wetted with a pore-forming material 11 before operation at a0) 28. The active material 4 is calendered during operation at a) 27 and before operation at a1) 29 in a operation at a0) 28. The calendering process has already been explained above. The calender 16 comprises a plurality of calender rollers 17. The active material 4 is subjected to a calendering force in a deformation zone via the calender rollers 17 and compressed.

In a subsequent operation at a1) 29, the copolymer 5 is applied to the active material 4 as a coating 10. The coating 10 is wetted with a pore-forming material 11 during operation at a) 27. The coating 10 wetted with the material 11 is calendered again in operation at a2) 30.

The first electrode 1 is cut to a geometry 12 predetermined for operation in a battery cell 2 before operation at b) 31 in an operation at a3) 32. The cutting of the base body 3 designed as continuous material 39 comprises a slitting (cutting line runs along the extension, x-direction or conveying direction 46, of the continuous material 39 to divide the wide starting material of the base body 3 into several less wide strips of continuous material 39), a notching (the current arresters 38 are formed out of the continuous material 39 with the cutting line; the cutting lines run longitudinally and transversely to the extension of the continuous material 39, i.e., e.g., along the y-direction and the x-direction of the continuous material 39), and/or a separating (cutting line runs transversely to the extension of the continuous material 39 along the y-direction; by separating, the base bodies 3 are separated from the continuous material 39 and the individual layers or electrodes 1, 13 of the stack 14 are formed).

In a subsequent operation at a4) 33, the trimmed first electrode 1 or the base body 3 is dried. During this process, the pore-forming material 11 evaporates and forms pores in the active material 4 and in the coating 10.

In a subsequent operation at a5) 34, the electrodes 1, 13 and possibly a separator 40 are stacked to form the stack 14.

In a subsequent operation at a6) 35, the stack 14 is arranged in a housing 15.

The subsequent operation at b) 31 is divided into an operation at b1) 36, the addition of the liquid electrolyte 6, and an operation at b2) 37, the formation of a gel polymer electrolyte 7 by reaction of the copolymer 5 with the liquid electrolyte 6 and the formation of the first electrode 1.

It should be noted that the addition of the pore-forming material 11 can be carried out optionally in each case.

FIG. 2 shows a sequence of a second disclosed embodiment of a method. Here, the second electrode 13 is a lithium metal anode that is not to be exposed to the liquid electrolyte 6. Reference is made to the explanations in FIG. 1.

In contrast to the first disclosed embodiment, here only the cathode is produced by the method as the first electrode 1. Operation at b) 31 therefore takes place after operation at a3) 32, the trimming. According to operation at b) 31, the liquid electrolyte 6 is added and a gel polymer electrolyte 7 is formed by reacting the copolymer 5 with the liquid electrolyte 6 and forming the first electrode 1.

In a subsequent operation at a5) 34, the electrodes 1, 13 and possibly a separator 40 are stacked to form the stack 14.

In a subsequent operation at a6) 35, the stack 14 is arranged in a housing 15.

FIG. 3 shows a sequence of a third disclosed embodiment of a method. Reference is made to the comments on FIGS. 1 and 2.

In contrast to the other exemplary embodiments, the copolymer 5 is mixed here in operation at a) 27 with the active material 4 to form a material mixture 8 and the material mixture 8 is arranged on a carrier material 9. The copolymer 5 is evenly distributed in the material mixture 8. If the gel polymer electrolyte 7 is then formed in operation at b) 31, the gel polymer electrolyte 7 is also evenly distributed in the material mixture 8 of the first electrode 1 that is then formed.

The active material 4 is wetted with a pore-forming material 11 before operation at a0) 28. The active material 4 is calendered during operation at a) 27 and before operation at a1) 29 in an operation at a0) 28. The first electrode 1 is trimmed to a geometry 12 predetermined for operation in a battery cell 2 in an operation at a3) 32 before operation at b) 31.

In a subsequent operation at a4) 33, the trimmed first electrode 1 or the base body 3 is dried. During this process, the pore-forming material 11 evaporates and forms pores in the material mixture 8.

In contrast to the first disclosed design option, only the cathode is produced here as the first electrode 1 by the method. Operation at b) 31 therefore takes place after operation at a3) 32, the trimming. According to operation at b) 31, the liquid electrolyte 6 is added and a gel polymer electrolyte 7 is formed by reacting the copolymer 5 with the liquid electrolyte 6 and forming the first electrode 1.

In a subsequent operation at a5) 34, the electrodes 1, 13 and possibly a separator 40 are stacked to form the stack 14.

Operation at a1) 29, i.e., the arrangement of the copolymer 5 as a coating 10 on the material mixture 8, is not necessarily provided for here.

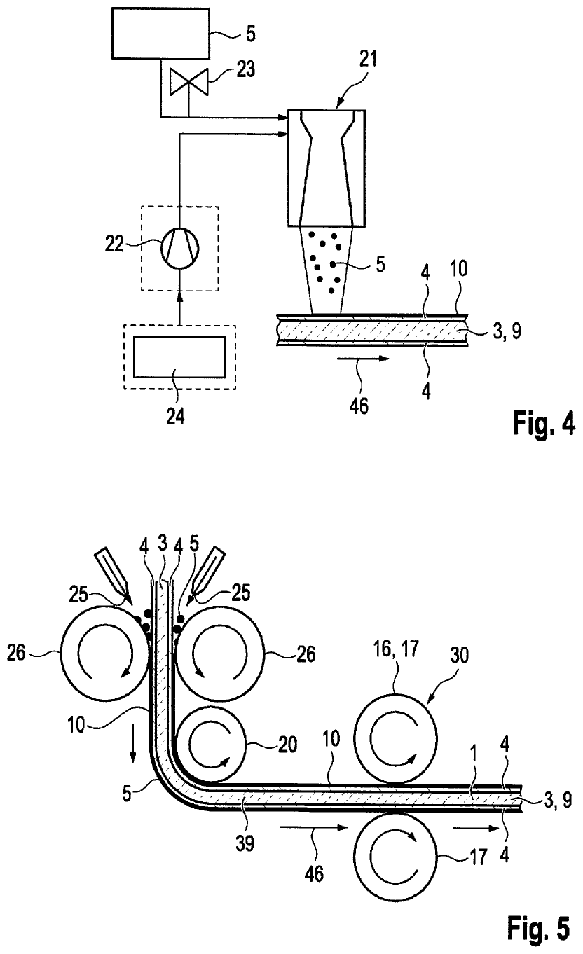

FIG. 4 shows a side view of a first disclosed embodiment of a device for applying a coating 10.

The copolymer 5 is sprayed onto the surface of the base body 3 (i.e., only the active material 4) using a Venturi-based nozzle 21 (also referred to as high-speed blasting or high-speed blasting process). The nozzle 21 is supplied with dry air 24 under high pressure (approx. 6 bar). For this purpose, the air 24 is compressed in a compressor 22. The supply of copolymer 5 is controlled via a valve 23. The copolymer particles enter the nozzle 21. The high air pressure is converted into a high air velocity. The high velocity air (maximum 0.3 to 4 Mach) takes the copolymer particles with it and bombards them onto the surface of the base body 3, in particular, the already calendered surface. In this way, a thin coating 10 with a thickness of a few μm (micrometers) can be produced.

FIG. 5 shows a side view of a second disclosed embodiment of a device for applying a coating 10. The base body is fed as continuous material 39 to a pair of pressure rollers 26. The copolymer 5 fed via an outlet 25 is bonded to the base material 9 via the pressure rollers 26. The first electrode 1 is transported further to the calender 16 and operation at a2) 30 via conveyor rollers 20. The coating 10 wetted with the material 11 is calendered again in operation at a2) 30.

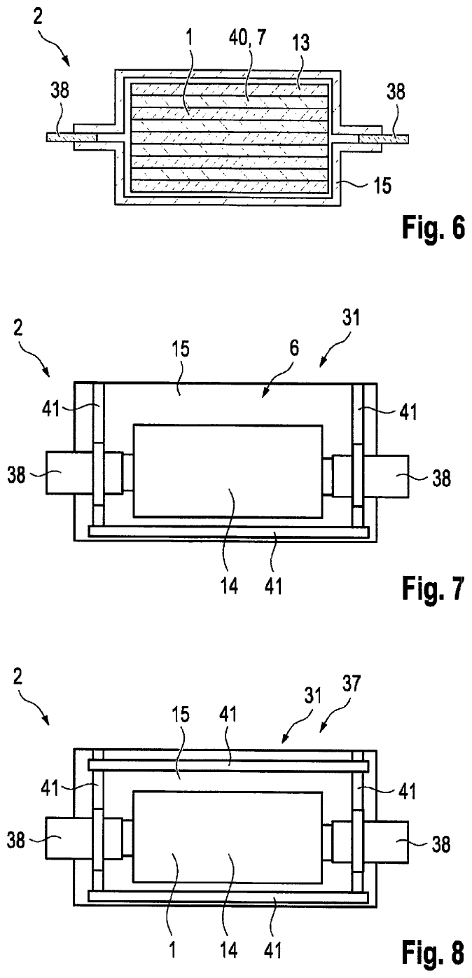

FIG. 6 shows a side view of a battery cell 2 in section. The battery cell 2 comprises a housing 15 enclosing a volume and, arranged in the volume, a plurality of first electrodes 1 of a first electrode type, a plurality of second electrodes 13 of a second electrode type and a separator 40 or a solid (also gel-like) electrolyte 6 arranged between them. The current arresters 38 of the electrodes 1, 13 extend out of the housing 15. The housing 15 is sealed gas-tight.

FIG. 7 shows a battery cell 2 during operation at b) 31 of the process. The housing 15 is already partially sealed via sealing seams 41. The current arresters 38 extend outwards over the housing 15.

According to operation at a6) 35, the stack 14 is arranged in the housing 15. According to operation at b1) 36, the liquid electrolyte 6 is added via a still unsealed side of the housing 15.

FIG. 8 shows the battery cell 2 according to FIG. 7 after operation at b) 31. As part of operation at b) 31, the housing 15 is now finally closed. In operation at b2) 37, a gel polymer electrolyte 7 is formed by reacting the copolymer 5 with the liquid electrolyte 6 and forming the first electrode 1.

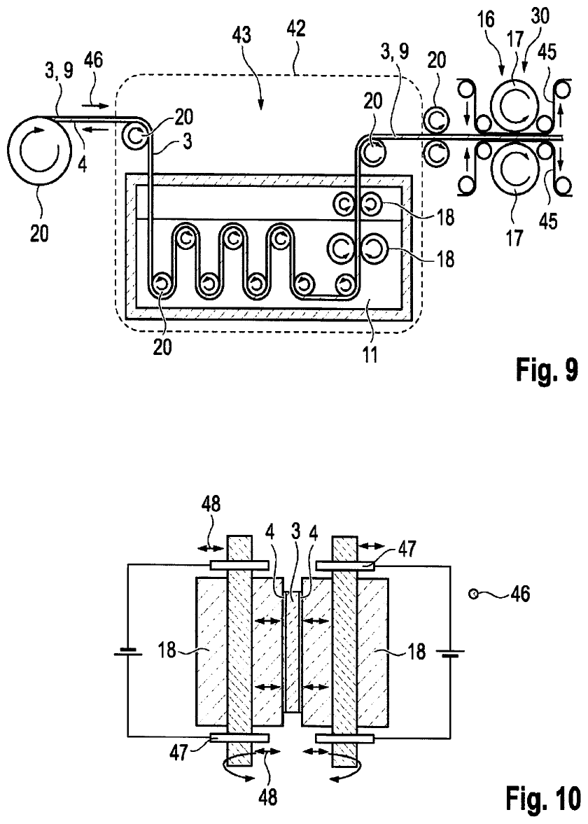

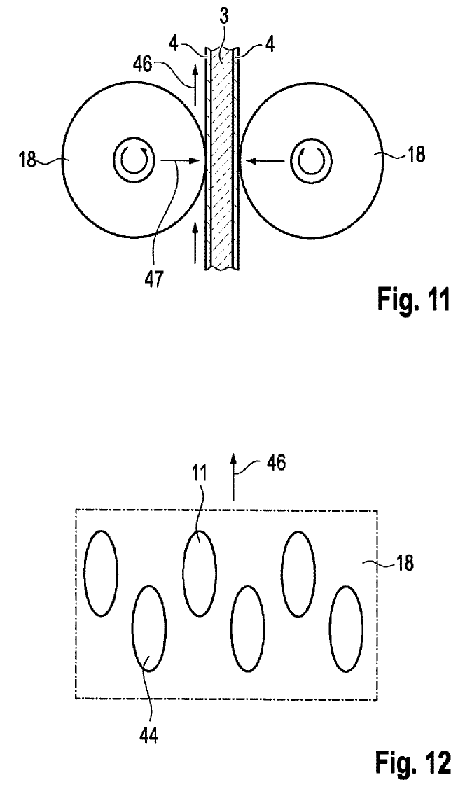

FIG. 9 shows part of the method. Operations at a0) 28 is shown here, i.e., the (first) calendering and wetting of the active material 4 before operation at a0) 28 with a pore-forming material 11. The active material 4 is calendered during operation at a) 27 and before operation at a1) 29 in an operation at a0) 28. The base body 3 is passed through a tank 42 filled with the pore-forming material 11 for wetting with the pore-forming material 11. The pore-forming material 11 comprises, for example, DMC (dimethylene carbonate). The tank 42 filled with DMC is pressurized by nitrogen gas 43 so that no outside air can penetrate. When the first electrode 1 passes through the tank 42 as continuous material 39, the pore-forming material 11 penetrates into the pores of the active material 4. A wetting roller 18 is provided, which exerts pressure on the base body 3 so that more of the pore-forming material 11 enters the active material 4 of the base body 3 as a result of the mechanical pressure. The wetting roller 18 causes a microstructure 44 on the surface of the base body 3 (see FIG. 12). In this way, more material 11 will adhere to the surface of the base body 3 in the pores and/or micropores.

Wiper/scraper rollers 19 are also provided to remove excess pore-forming material from the surface of the base body 3. The excess pore-forming material 11 can be returned to the tank 42.

The pores of the base body 3 are then filled with the pore-forming material. 11 The base body 3 is then calendered in an operation at a2) 30.

During calendering according to operation at a2) 30, a (polyurethane) protective film 45 is used on both sides, for example. In this way, the material 11 will not escape from the sides of the base body 3. The polyurethane protective film 45 is placed on the base body 3 before it enters the calender rollers 17 and is rewound after it exits the calender 16. In this way, the same protective film 45 can be used repeatedly.

FIG. 10 shows the wetting rollers 18 according to FIG. 9 in a view along the conveying direction 46. FIG. 11 shows the wetting rollers 18 according to FIG. 10 in a side view. FIG. 12 shows a microstructure 44 of the wetting rollers 18 according to FIGS. 10 and 11. FIGS. 10 to 12 are described together below. Reference is made to the comments on FIG. 9.

The wetting rollers 18 are additionally excited to vibrate 48 by an excitation device 47. The wetting rollers 18 exert a pressure on the base body 3, so that more of the pore-forming material 11 reaches the active material 4 of the base body 3 due to the mechanical pressure. The wetting rollers 18 have a microstructure 44 and thus cause a microstructure 44 on the surface of the base body 3 (see FIG. 12). The individual shapes of the microstructure 44 have a depth of approx. 20 μm and a maximum width of approx. 5 μm. In this way, more material 11 will adhere to the surface of the base body 3 in the pores or micropores.

### LIST OF REFERENCE NUMBERS

1 first electrode
2 (solid-state) battery cell
3 base body
4 active material
5 copolymer
6 electrolyte
7 gel polymer electrolyte
8 material mixture
9 carrier material
10 coating
11 material
12 geometry
13 second electrode
14 stack
15 housing
16 calender
17 calender roller
18 wetting roller
19 scraper roller
20 conveyor roller
21 nozzle
22 compressor
23 valve
24 air
25 outlet
26 pressure roller
27 operation at a)
28 operation at a0)
29 operation at a1)
30 operation at a2)
31 operation at b)
32 operation at a3)
33 operation at a4)
34 operation at a5)
35 operation at a6)
36 operation at b1)
37 operation at b2)
38 current arrester
39 endless material
40 separator
41 scaling scam
42 tank
43 nitrogen gas
44 microstructure
45 polyurethane protective film
46 conveying direction
47 excitation device
48 vibration

1. A method of manufacturing a first electrode of a battery cell, the method comprising:
producing a base body of the first electrode, the base body including at least an active material of the first electrode and a copolymer; and
wetting the base body with a liquid electrolyte
to form a gel polymer electrolyte by reaction of the copolymer with the liquid electrolyte, to create the first electrode.

2. The method of claim 1, further comprising:
mixing the copolymer with the active material to form a material mixture; and
arranging the material mixture on a carrier material.

3. The method of claim 1, wherein the copolymer is applied as a coating to the active material in during the production of the base body.

4. The method of claim 3, wherein the active material is calendered in during the production of the base body before application of the copolymer as a coating to the active material.

5. The method of claim 4, wherein the active material is wetted with a pore-forming material during the production of the base body and before or during the calendaring of the active material.

6. The method of claim 3, wherein the coating is wetted with a pore-forming material during the production of the base body.

7. The method of claim 2, wherein the material mixture is wetted with a pore-forming material during the production of the base body.

8. The method of claim 5, wherein the pore-forming material is at least partially removed from the base body before the formation of the gel polymer electrolyte.

9. The method of claim 1, wherein the base body is calendered prior to the formation of the gel polymer electrolyte.

10. The method of claim 1, wherein the base body is free of gel polymer electrolyte immediately before formation of the gel polymer electrolyte.

11. The method of claim 1, further comprising trimming the first electrode to a geometry predetermined for operation in a battery cell before formation of the gel polymer electrolyte.

12. The method of claim 1, further comprising drying the first electrode between the production of the base body and the formation of the gel polymer electrolyte.

13. The method of claim 1, further comprising stacking the first electrode (1) is arranged stacked with at least one second electrode after the production of the base body and before the formation of the gel polymer electrolyte to form a stack.

14. The method of claim 11, wherein the stack is arranged in a housing of the battery cell before the formation of the gel polymer electrolyte.

15. The method of claim 1, further comprising supplying at least thermal or mechanical energy to activate the reaction that forms the gel polymer electrolyte.
